(19) United States
(12) Patent Application Publication
(10) Pub. No.: US 2020/0032082 A1
(43) Pub. Date: Jan. 30, 2020

(54) OIL PAINTS RECYCLING

(71) Applicant: HUZAIFA HATIMBHAI MATAWALA, Newyork, NY (US)

(72) Inventor: HUZAIFA HATIMBHAI MATAWALA, Newyork, NY (US)

(21) Appl. No.: 16/048,083

(22) Filed: Jul. 27, 2018

(51) Int. Cl. C09D 7/20; C09D 7/80

(52) U.S. Cl. CPC C09D 7/20; C09D 7/80

(57) ABSTRACT

After a detailed scientific study from several years. We are working in the industry from 5 decades, now as a third generation serving presence in multiple continents in recycling, manufacturing of paints and raw materials. We look forward to serve solutions. Covering the current issue to the unused oil paints, resins, solvents, washed batches and rejections of Haz mat paint or raw materials to reusable solution. We apply for patent in UNITED STATES PATENT AND TRADEMARK OFFICE for Oil paint Recycling. With a vision to initiate a process of oil paints reuse and recycling.

### BACKGROUND OF INVENTION

Paint industry have entered into an era of continuous enhancement of chemistry from various perspectives of customer requirements, costings, environment, durability and reach. It is always challenging for research and development team for creation of ecofriendly paints with proper costings and product performance. Every year we import millions of barrels of crude, hydrocarbons, petrochemical raw materials. Millions of gallons of these items are integrated in paint productions. We can cut a considerable amount of these buying and foreign debts.

Several formulations are edited and product is enhanced. The industry has changed most rapidly and fastest with formulations in past decade than ever before. The process of change leaves us with several batches, raw materials, and stock of items that need to be replaced with newer ingredients. With the changes in environmental norms, the EPA laws, concerns with higher VOC paints and climatic and natural ecosystem impact of paints we deliver newer products in the market This is occurred in factory store levels with several raw material industries in US, Canada and Europe. The more we alter into newer formulations, we leave back an inventory of raw material and stock that is no longer usable to the industry. We leave batches and items that cannot be utilized and hence failure batches and obsolete raw materials with paint raw material manufacturers.

With an experience of the industry with different type of resins, pigments, additives, solvents and paints, we come forward with a program of reusability of the batch failures, obsolete materials, gelled batches, washed solvents, mis-tints, customer returns, non-usable, non-salable raw materials or paints of all type to use. Our attempt is to reduce the waste generation from the factory process itself by finding use of the items into our line of products. Once we are able to ascertain the chemistry, ingredients, compatibility, resin and solvent nature, the reuse of the items can be ascertained.

### BRIEF SUMMARY OF INVENTION

We would like to share some data and possibilities on working with oil paints and solvents. There is an extensive use of Oil paints and solvents internationally as a durable easy solution. The advanced ecofriendly water based formulations have not reached several countries across the globe and traditional solvent based coating system still provides an essential coating solution worldwide.

We have successfully reached solutions for latex based paints reuse. With every passing year we are able to convert more and more cans of latex paints into a new recycled product. We have several projects for procuring the latex paint cans from the market, homes, industries and counties. These are used into productions of stucco, plasters, driveway sealers and recycled latex based paints.

We study the current scenario of fuel blending and land burial impacts of oil paints on the environment. Covering the topics on Oil Paints saving from fuel blending or land burial. For several manufacturers of paints, resin factories & Paint recycling companies we share a study analyzing oil paints and solvents reusability option from a more wider global perspective.

When we study the lifecycle of paints from its origin to modifications including processes creating raw materials and the blending into a final paint product. We will also see in the below report its process, how it effects the environmental system and how reuse of oil paints benefits both economically and ecologically. As a solution we can save the solvent based paints if we make a study that describes the functions, purpose and ingredients of the solvent based paints.

Our INTENTION TO PATENT is to cover a total program of recreating a product form the solvent based paints.

Our intention is to have a final brand of such product into the market from local facility. Hereby create more value-able products with experience and judgement on the recycling. The use of these coatings are minimal in the developed countries, but can serve as a major help in the economies that need infrastructural development. The infrastructural zones of the developing countries can be served with the durable healthy products, that are created from the solvents and oil paints. We have markets who use these items as an economical coating to protect the items.

We produce the Bitumen paints and several coatings that use the lower end resins and solvents in the formulations. Such primers serve as an undercoat. We have replaced bitumen coat formulations with these recycled paints. We have also formulated several primers for wood and metals. The salty humid and dry extreme climates require a coat that protects the surface, prevent the erosion on walls and keep the structure stand for longer. There products have been tested in market and been approved as it passed the requirements and functions.

Fuel blending may be appropriate with the other petrochemicals or oils or flammable items. Solvent based paints like alkyd enamels, stains, solvent based ink products, primers, paint thinners, tank washed solvents, Alkyd resins, epoxies, hardner, etc. can reach a solution of reutilization. Savings on costs, ingredients and environment.

We can recycle, classify, rectify, and re-utilize in a very cost efficient matter.

### PROCESS AND FORMULATIONS

The solvent based paints and resins mainly feature on below steps and procedure.
A) Solvents and Resin Structure, compatibility, density, boiling points study
B) Sorting, Batch making & Productions.
C) Formulations.

A) Solvents and Resin Compatability Study.
Solvents play a very important role in recycling paints and resins, as they determine the compatibility and the house of recycling family the paint or resin will go to. If we initiate manufacturing process without a proper understanding and study we can have non favorable batches. Material may turn into cake like formations, lumps, chips, harden like rock or lose its viscosity. The possibilities of having a successful recycling is based on the study of the molecular structure, boiling paints, dispersing ability, and density of the solvent used in paint or resin.

Because numerical values are used, comparisons can be made rationally by comparing numbers. For example, acetonitrile is much more polar than acetone but exhibits slightly less hydrogen bonding.

On study of the detailed characteristic property of the bond of solvent with resin, pigment metals and filler we can ascertain the use and breaking of such bonds into newer or similar products for use.

For example toluene and benzene solvents are better compatible with xylene than mineral spirits. However xylene is compatible with mineral spirits as well. Certain solvents are soluble with each other, some are soluble to an extent only, some are non-soluble at all. Solvents when reacted with resins and pigments change the loyalty towards their house becoming more easily compatible most of the time. The use of additives, extenders and fillers play an important role.

B) Sorting, Batch Makings & Productions.
Once we have classified the groups of compatibles together in the groups we sort the materials on the basis of sheen, colors, density, and gloss. Depending on the inventory the products with common sheens, colors, density and sheens are together mixed into batch sizes as an intermediate pulp. This is an important ingredient mix check stage where pulp is created from the oil paint, resin, solvent, pigment, waste/scrap/lots. These Pulps are usually made keeping in mind the usability for the final product. We again check the batches of the pulps on the final gloss, resin-solvent-pigment-filler ratio on the basis of density, hardness, gloss, weight and viscosity.
We finally do crafting final product batches of the Floor paints, Primer paints, stucco items, texture coatings, top coats, Bitumen paints, etc. All the formulations, blends, processes, other ingredients mix remain an important part of chemistry. These various products are served in several brands and markets. We are able to serve the markets with final recycled product that saved the important ingredients from land burial or fuel blending. It is also created without extraction of resources occurring in savings of energy thus environmentally beneficial.
All the batch making and production efforts are extremely essential stages where presence of mind and acute checks are needed all the time. The batches of pulps can have significant variances as to the properties due to variety of mixes. As always explained in several illustrations the process needs to be very closely checked and examined on stages to avoid production failures. In case of a failure, we are exposed to wastage of time and the obtained failed batch again is kept for further rework. Such material is gradually mixed in dosages of small percentages in acceptable batches.
With the presence of the reactive chemistry in all the ingredients, there are changes in properties with several components over the period of time. The effect of exposure to climate, heat, cold, time, contamination and reactions with other items need to be taken in consideration. Most of the reactive ingredients lose its power, however when we formulate the pulp batches and mixes, we keep in consideration properties and capability to react, form compound, molecules and give us the desired product in return.

C) Formulations.

### Gloss Alkyd Enamels from Recyled Items

| INGREDIENTS. | PERCENTAGE |
|---|---|
| BULKED SOLVENT BASED RECYCLED PAINTS | 35-55% |
| ALKYDS | 25-30% |
| SOLVENTS | 10-20% |
| DRIERS | 1%-2% |
| cobalt | |
| manganese | |
| calcium | |
| zirconium | |
| ANTI SETTLING AGENTS | 2% |
| GRINDING MEDIA | 2% |
| PIGMENT | 5%-20% |

Mix the alkyds and solvents with the bulked solvent based recycled paints. Use the hi speed stirrers to blend with the approximate speed of 1600 rpm. Additions of pigments, additions of solvents and alkyds may vary to obtain desired gloss, solid in percentages and durability aspects of the final products.

Blending and filtering is essential to the extent we obtain a homogenous perfect shade, grind, gloss, dry, hardness of the product.

### Alkyd Stains from Recyled Items

| INGREDIENTS. | PERCENTAGE |
|---|---|
| BULKED SOLVENT BASED RECYCLED PAINTS | 35-55% |
| ALKYDS | 25-30% |
| SOLVENTS | 10-20% |
| DRIERS | 1%-2% |
| cobalt | |
| manganese | |
| calcium | |
| zirconium | |
| ANTI SETTLING AGENTS | 2% |
| GRINDING MEDIA | 2% |
| PIGMENT | 5%-20% |

We can use the clear and light colored bulked items to get the alkyd stains. Mix the alkyds and solvents with the bulked solvent based recycled paints. Use the hi speed stirrers to blend with the approximate speed of 1600 rpm. Additions of pigments, additions of solvents and alkyds may vary to obtain desired gloss, solid in percentages and durability aspects of the final products.

Blending and filtering is essential to the extent we obtain a homogenous perfect shade, grind, gloss, dry, hardness of the product.

### Matte Alkyd Enamels from Recyled Items

| INGREDIENTS. | PERCENTAGE |
|---|---|
| BULKED SOLVENT BASED RECYCLED PAINTS | 35-50% |
| ALKYDS | 15-25% |
| SOLVENTS | 10-20% |
| DRIERS | 1%-2% |
| cobalt | |
| manganese | |
| calcium | |
| zirconium | |
| ANTI SETTLING AGENTS | 2% |
| GRINDING MEDIA | 2% |
| PIGMENT | 5%-20% |
| EXTENDERS | 30-50% |
| (Talc, calcium carbonate, calcite, silicate) | |

Mix the alkyds and solvents with the bulked solvent based recycled paints. Use the hi speed stirrers to blend with the approximate speed of 1600 rpm. Additions of pigments, additions of solvents and alkyds may vary to obtain desired gloss, solid in percentages and durability aspects of the final products.

Mix the extenders gradually in the solution to obtain the matte finish in the paint.

Blending and filtering is essential to the extent we obtain a homogenous perfect shade, grind, gloss, dry, hardness of the product.

### Anti Corrossive Red Oxide Matte Primer from Recyled Items

| INGREDIENTS. | PERCENTAGE |
|---|---|
| BULKED SOLVENT BASED RECYCLED PAINTS | 35-50% |
| ALKYDS | 15-25% |
| SOLVENTS | 10-20% |
| DRIERS | 1%-2% |
| cobalt | |
| manganese | |
| calcium | |
| zirconium | |
| ANTI SETTLING AGENTS | 2% |
| GRINDING MEDIA | 2% |
| PIGMENT | 5%-20% |
| EXTENDERS | 20-30% |
| (Talc, calcium carbonate, calcite, silicate) | |
| RED OXIDE PIGMENT | 5-20% |

Mix the alkyds and solvents with the bulked solvent based recycled paints. Use the hi speed stirrers to blend with the approximate speed of 1600 rpm. Additions of pigments, additions of solvents and alkyds may vary to obtain desired gloss, solid in percentages and durability aspects of the final products.

Mix the extenders gradually in the solution to obtain the matte finish in the paint.

Mix the red oxide pigment to achieve the anticorrosive feature to the paint.

Blending and filtering is essential to the extent we obtain a homogenous perfect shade, grind, gloss, dry, hardness of the product.

### Semi Gloss/Satin/Egg Shell Finishes of Alkyd Enamels from Recyled Items

| INGREDIENTS. | PERCENTAGE |
|---|---|
| BULKED SOLVENT BASED RECYCLED PAINTS | 35-50% |
| ALKYDS | 15-25% |
| SOLVENTS | 10-20% |
| DRIERS | 1%-2% |
| cobalt | |
| manganese | |
| calcium | |
| zirconium | |
| ANTI SETTLING AGENTS | 2% |
| GRINDING MEDIA | 2% |
| PIGMENT | 5%-20% |
| EXTENDERS | 10-20% |
| (Talc, calcium carbonate, calcite, silicate) | |

Mix the alkyds and solvents with the bulked solvent based recycled paints. Use the hi speed stirrers to blend with the approximate speed of 1600 rpm. Additions of pigments, additions of solvents and alkyds may vary to obtain desired gloss, solid in percentages and durability aspects of the final products.

Mix the extenders gradually in the solution to obtain the desired finish in the paint. More the extender more the sheen gets reduced.

Blending and filtering is essential to the extent we obtain a homogenous perfect shade, grind, gloss, dry, hardness of the product.

### Bitumen Primer from Recyled Items

| INGREDIENTS. | PERCENTAGE |
|---|---|
| BULKED SOLVENT BASED RECYCLED PAINTS | 30-50% |
| ALKYDS | 5-10% |
| BITUMEN 60/70 | 10-25% |
| SOLVENTS | 10-20% |
| DRIERS | 1%-2% |
| cobalt | |
| manganese | |
| calcium | |
| zirconium | |
| ANTI SETTLING AGENTS | 2% |
| GRINDING MEDIA | 2% |
| PIGMENT | 5%-20% |
| EXTENDERS | 25-40% |
| (Talc, calcium carbonate, calcite, silicate) | |
| BLACK OXIDE PIGMENT | 5-10% |
| WATER | 0-40% |

Mix the alkyds and solvents with the bulked solvent based recycled paints. Use the hi speed stirrers to blend with the approximate speed of 1600 rpm. Additions of pigments, additions of solvents and alkyds may vary to obtain desired gloss, solid in percentages and durability aspects of the final products.

Bitumen is mixed in hot form into the solution of recycled paint.

Mix the extenders gradually in the solution to obtain the matte finish in the paint.

Mix black pigments to obtain the jet black color required to manufacture the primer.

Addition of water in the end to the extent the compatibility and acceptances of the batch.

Addition of water effects the sheen, durability, hardness, drying capability of the paint.

Addition of water is however not commended. But it reduces the costings

Blending and filtering is essential to the extent we obtain a homogenous perfect shade, grind, gloss, dry, hardness of the product.

In batches of the bitumen paints we can use the variety of solvents, epoxies, industrial coatings.

### Bitumen Emulsion from Recyled Items

| INGREDIENTS. | PERCENTAGE |
|---|---|
| BULKED SOLVENT BASED RECYCLED PAINTS | 20-30% |
| ALKYDS | 5-10% |
| BITUMEN 60/70 | 10-25% |
| SOLVENTS | 10-20% |
| DRIERS | 1%-2% |
| cobalt | |
| manganese | |
| calcium | |
| zirconium | |
| ANTI SETTLING AGENTS | 2% |
| GRINDING MEDIA | 2% |
| PIGMENT | 5%-20% |
| EXTENDERS | 25-40% |
| (Talc, calcium carbonate, calcite, silicate) | |
| BLACK OXIDE PIGMENT | 5-10% |
| WATER | 20-40% |
| BENTONITE | 5-15% |

Mix the alkyds and solvents with the bulked solvent based recycled paints. Use the hi speed stirrers to blend with the approximate speed of 1600 rpm. Additions of pigments, additions of solvents and alkyds may vary to obtain desired gloss, solid in percentages and durability aspects of the final products.

Bitumen is mixed in hot form into the solution of recycled paint.

Mix the extenders gradually in the solution to obtain the matte finish in the paint.

Mix black pigments to obtain the jet black color required to manufacture the primer.

Mixing of bentonite during the process enhances the acceptability of water with solvent based items.

Addition of water in the end to the extent the compatibility and acceptances of the batch.

Addition of water effects the sheen, durability, hardness, drying capability of the paint.

Addition of water is however not commended. But it reduces the costings

Blending and filtering is essential to the extent we obtain a homogenous perfect shade, grind, gloss, dry, hardness of the product.

This is a primer product water based in nature with durability of bitumen as a resin.

In batches of the bitumen paints we can use the variety of solvents, epoxies, industrial coatings.

### Extra Durable Bitumen Emulsion SBR from Recyled Items

| INGREDIENTS. | PERCENTAGE |
|---|---|
| BULKED SOLVENT BASED RECYCLED PAINTS | 20-30% |
| BITUMEN 60/70 | 10-25% |
| SOLVENTS | 10-20% |
| DRIERS | 1%-2% |
| cobalt | |
| manganese | |
| calcium | |
| zirconium | |
| ANTI SETTLING AGENTS | 2% |
| GRINDING MEDIA | 2% |
| PIGMENT | 5%-20% |
| EXTENDERS | 25-40% |
| (Talc, calcium carbonate, calcite, silicate) | |
| BLACK OXIDE PIGMENT | 5-10% |
| WATER | 20-40% |
| BENTONITE | 5-15% |
| STYRENE ACRYLIC EMULSION | 5-15% |

Mix the alkyds and solvents with the bulked solvent based recycled paints. Use the hi speed stirrers to blend with the approximate speed of 1600 rpm. Additions of pigments, additions of solvents and alkyds may vary to obtain desired gloss, solid in percentages and durability aspects of the final products.

Bitumen is mixed in hot form into the solution of recycled paint.

Mix the extenders gradually in the solution to obtain the matte finish in the paint.

Mix black pigments to obtain the jet black color required to manufacture the primer.

Mixing of bentonite during the process enhances the acceptability of water with solvent based items.

Addition of water in the end to the extent the compatibility and acceptances of the batch.

Addition of water effects the sheen, durability, hardness, drying capability of the paint.

Addition of water is however not commended. But it reduces the costings

Blending and filtering is essential to the extent we obtain a homogenous perfect shade, grind, gloss, dry, hardness of the product.

This is a primer product water based in nature with durability of bitumen as a resin.

Use of styrene acrylic emulsion binder is essential to obtain the extra durability.

In batches of the bitumen paints we can use the variety of solvents, epoxies, industrial coatings.

### Bitumen Mastics (Putty) from Recyled Items

| INGREDIENTS. | PERCENTAGE |
|---|---|
| BULKED SOLVENT BASED RECYCLED PAINTS | 20-30% |
| ALKYDS | 5-10% |
| BITUMEN 60/70 | 10-25% |
| SOLVENTS | 1-25% |
| DRIERS | 1%-2% |
| cobalt | |
| manganese | |
| calcium | |
| zirconium | |
| ANTI SETTLING AGENTS | 2% |
| GRINDING MEDIA | 2% |
| PIGMENT | 5%-20% |
| EXTENDERS | 25-40% |
| (Talc, china clay, calcium carbonate, calcite, silicate) | |
| BLACK OXIDE PIGMENT | 5-10% |
| WATER | 10-20% |

Mix the alkyds and solvents with the bulked solvent based recycled paints. Use the hi speed stirrers to blend with the approximate speed of 1600 rpm. Additions of pigments, additions of solvents and alkyds may vary to obtain desired gloss, solid in percentages and durability aspects of the final products.

Bitumen is mixed in hot form into the solution of recycled paint.

Mix the extenders gradually in the solution to obtain the matte finish in the paint.

Mix black pigments to obtain the jet black color required to manufacture the primer.

Water is a part of the process, it is essential part of chemistry.

Blending and filtering is essential to the extent we obtain a homogenous perfect shade, grind, gloss, dry, hardness of the product.

We use the mastics and putty to fill in the cracks of the ceiling, walls, between the tiles.

In batches of the bitumen paints we can use the variety of solvents, epoxies, industrial coatings.

### SCOPE

The scope of recycling is based on the requirement of paint reuse projects, cost/financial benefits, Research and developments

As an environmental lifecycle calculation the cost of solvent based paint on extraction is about twice as the cost of disposal above.

Processes and cost of obtaining the paint from nature is saved when paint is reused.

For example, when resins are cooked in a reactor with the amines, natural agricultural oils, phallic anahydrides, penta, maelic and monomers. The process utilizes energy, resources, power and rare blends of nature. If we are able to reuse the paint, we save the ingredients and the energy that were to be spent on creation of those raw materials.

On a contrary when we fuel blend these items in fire we are unable to use an opportunity to save them. The cycle of generation of newer resins, solvents, metallic driers, pigments, additives, etc. has to take place. We have to extract the more gums from more trees, erode more mountains for minerals, extract the oils from the sea to create speciality monomers and hydrocarbons to attain solvent based paints. Such saving is much more in value and utility than the fuel blending properties a paint can will provide. Also in most of the cases the Paints of certain grades do not help the burning process in-fact hamper the fuel blending costings.

1. (canceled)

2. (canceled)

3. (canceled)

4. (canceled)

5. I claim on the method of RECYCLING SOLVENT BASED PAINTS AND SOLVENTS to create RECYCLED PAINTS by using the steps of classifying products Into homogenous mixable solvent and resin categories, then sorting them as per sheen, color, density, further, to bulking the common groups together, TO finally use the bulked liquids Into batches of recycled paints BY ADDITIONS of any or all of the NEW VIRGIN solvents, water, driers, resins, additives, extenders and pigments.
